(19) United States
(12) Patent Application Publication
(10) Pub. No.: US 2016/0048060 A1
(43) Pub. Date: Feb. 18, 2016

(54) LIGHT SOURCE DEVICE FOR REFLECTIVE MICRODISPLAY PANEL

(71) Applicant: Himax Display, Inc., Tainan City (TW)

(72) Inventors: Kuan-Yu Chen, Tainan City (TW); Biing-Seng Wu, Tainan City (TW); Kuan-Hsu Fan-Chiang, Tainan City (TW); Hsien-Chang Tsai, Tainan City (TW); Yuet Wing LI, Tainan City (TW)

(21) Appl. No.: 14/706,990

(22) Filed: May 8, 2015

Related U.S. Application Data
(60) Provisional application No. 62/037,618, filed on Aug. 15, 2014.

(51) Int. Cl. G02F 1/1335

(52) U.S. Cl. CPC G02F 1/133615; G02F 1/133621; G02F 2001/133624; G02F 2001/133616

(57) ABSTRACT

The present invention provides a light source device for a reflective microdisplay panel is disclosed. The light source device comprises: a first light bar, disposed on a first side of the reflective microdisplay panel. The first light bar comprises: a substrate, a plurality of micro LED units, and a controlling unit. The micro LED units are formed on the substrate, each micro LED unit corresponding to a screen area of the reflective microdisplay panel. The controlling unit is coupled to the micro LED units, and utilized for controlling luminance of each of the micro LED units individually according to luminance of the screen areas of the reflective microdisplay panel.

### CROSS REFERENCE TO RELATED APPLICATIONS

This application claims the benefit of U.S. Provisional Application No. 62/037,618, filed on Aug. 15, 2014 and included herein by reference.

### BACKGROUND OF THE INVENTION

1. Field of the Invention

The present invention relates to a light source device, and more particularly, to a pixelated light source device for a reflective microdisplay panel.

2. Description of the Prior Art

In general liquid crystal on a silicon (LCoS) panels are of various sizes, e.g, 0.22 inches, 0.29 inches, 0.35 inches, 0.5 inches, or 0.7 inches, but the size of the conventional LED package is not able to be adjusted according to various sizes of the LCOS panels.

Please refer to FIG. 1. FIG. 1 shows a simplified diagram of a conventional LED package 100 for an LCOS panel 110, wherein the size of the LCOS panel 110 is 0.22 inches. An active area 112 of the LCOS panel 110 matches with the LED package 100, wherein the LED package 100 is a standard 4206 or 3806 side view LED package. However, there is a non-uniform problem for the LCOS panel 110 in this prior art since the conventional LED package 100 is not a pixelated light source.

Please refer to FIG. 2. FIG. 2 shows a simplified diagram of another conventional LED package 200 for an LCOS panel 210, wherein the size of the LCOS panel 210 is 0.29 inches. An active area 212 of the LCOS panel 210 matches with the LED package 200, wherein the LED package 200 is a standard 4206 or 3806 side view LED package. However, there are a size mismatch problem and a non-uniform problem for the LCOS panel 210 in this prior art.

### SUMMARY OF THE INVENTION

It is therefore one of the objectives of the present invention to provide a pixelated light source device so as to solve the above problem.

In accordance with an embodiment of the present invention, a light source device for a reflective microdisplay panel is disclosed. The light source device comprises: a first light bar, disposed on a first side of the reflective microdisplay panel. The first light bar comprises: a substrate, a plurality of micro LED units, and a controlling unit. The micro LED units are formed on the substrate, each micro LED unit corresponding to a screen area of the reflective microdisplay panel. The controlling unit is coupled to the micro LED units, and utilized for controlling luminance of each of the micro LED units individually according to luminance of the screen areas of the reflective microdisplay panel.

Briefly summarized, the light source device disclosed by the present invention can solve the size mismatch problem and improve the uniformity and contrast of the reflective microdisplay panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified diagram of a conventional LED package for a liquid crystal on a silicon (LCOS) panel.

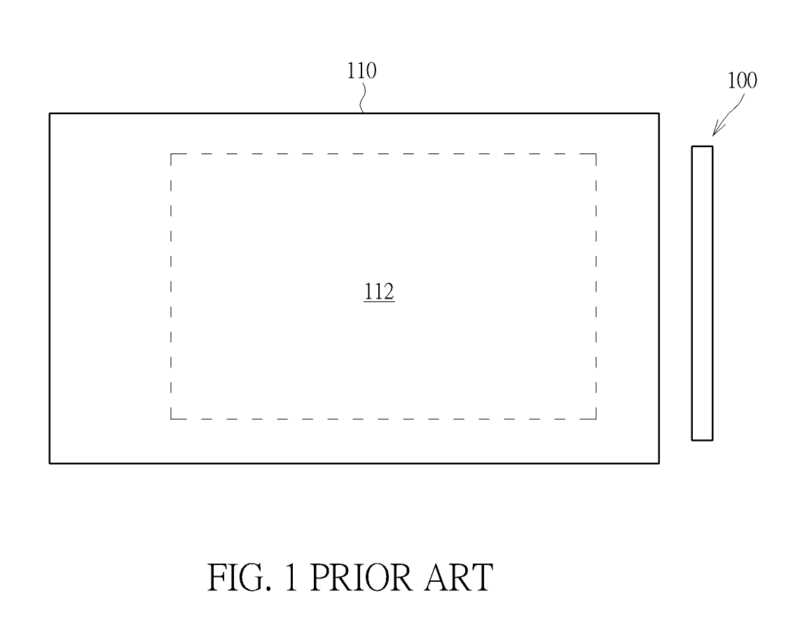

FIG. 2 shows a simplified diagram of another conventional LED package for an LCOS panel.

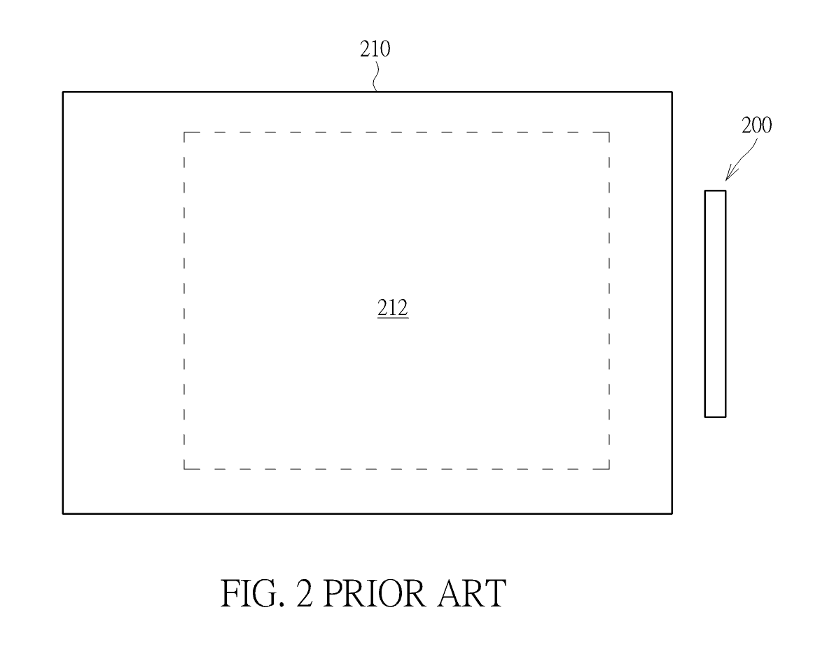

FIG. 3 shows a simplified diagram of a light source device for a reflective microdisplay panel in accordance with a first embodiment of the present invention.

FIG. 4 shows a simplified diagram of a light source device for a reflective microdisplay panel in accordance with a second embodiment of the present invention.

FIG. 5 shows a simplified diagram of a light source device for a reflective microdisplay panel in accordance with a third embodiment of the present invention.

FIG. 6 shows a simplified diagram of a light source device for a reflective microdisplay panel in accordance with a fourth embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

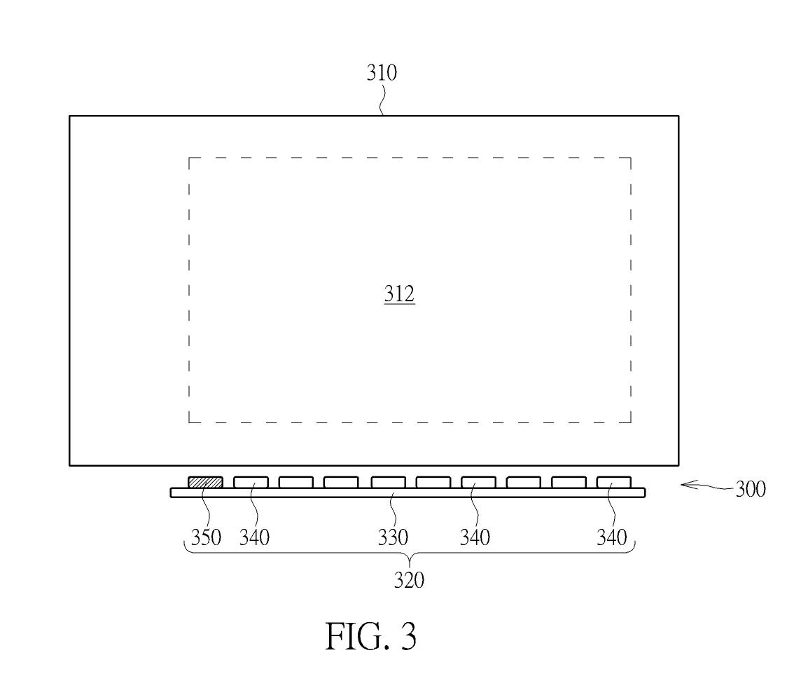

Please refer to FIG. 3. FIG. 3 shows a simplified diagram of a light source device 300 for a reflective microdisplay panel 310 in accordance with a first embodiment of the present invention, wherein the reflective microdisplay panel 310 can be a liquid crystal on a silicon (LCOS) panel, a DMD panel, or an epaper panel. The light source device 300 comprises a first light bar 320 disposed on a first side of the reflective microdisplay panel 310. The first light bar 320 comprises: a substrate 330, a plurality of micro LED units 340, and a controlling unit 350, wherein the substrate 330 can be a silicon substrate, and the size of the first light bar 320 can be adjusted according to the size of the reflective microdisplay panel 310. For example, the size of the reflective microdisplay panel 310 can be 0.22 inches, 0.29 inches, 0.35 inches, 0.5 inches, or 0.7 inches, and the size of the first light bar 320 can be adjusted accordingly.

The micro LED units 340 are formed on the substrate 330, and each micro LED unit 340 is corresponding to a screen area in an active area 312 of the reflective microdisplay panel 310, wherein each micro LED unit 340 is corresponding to a specific number of pixels of the reflective microdisplay panel 310. For example, the micro LED units 340 can be RGB LED units, wherein the RGB LED units can be formed in stripe arrangement or in delta arrangement, and the reflective microdisplay panel 310 is a front-lit color sequential (CS) Reflective microdisplay panel or an enhance color gamut front-lit color filter (CF) Reflective microdisplay panel. In another embodiment, the micro LED units 340 can be white LED units, and the reflective microdisplay panel 310 is a CF Reflective microdisplay panel. The controlling unit 350 is coupled to the micro LED units 340, and utilized for controlling luminance of each of the micro LED units 340 individually according to luminance of the screen areas in the active area 312 of the reflective microdisplay panel 310. In this way, the light source device 300 for the reflective microdisplay panel 310 is pixelated and can be controlled individually, wherein the size of the pixelated light source in the present invention is from 5 um to 0.5 mm, and the pixelated light source can be placed on a light bar or be grown on a single substrate (e.g. a silicon substrate), and the light source controller can be also integrated into the same substrate. Thus, the present invention can solve the size mismatch problem and improve the uniformity and contrast of the reflective microdisplay panel 310. Please note that the above embodiment is only for an illustrative purpose and is not meant to be a limitation of the present invention.

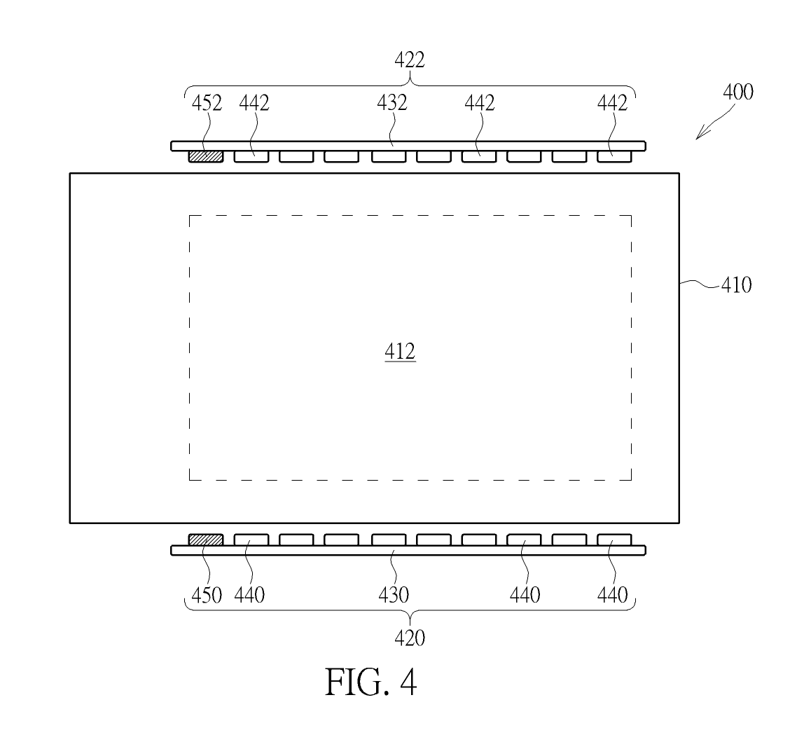

Please refer to FIG. 4. FIG. 4 shows a simplified diagram of a light source device 400 for a reflective microdisplay panel 410 in accordance with a second embodiment of the present invention. The light source device 400 comprises a first light bar 420 and a second light bar 422, wherein the first light bar 420 is disposed on a first side of the reflective microdisplay panel 410, and the second light bar 422 is disposed on a second side of the reflective microdisplay panel 410.

The first light bar 420 comprises: a substrate 430, a plurality of micro LED units 440, and a controlling unit 450, wherein the substrate 430 can be a silicon substrate, and the size of the first light bar 420 can be adjusted according to the size of the reflective microdisplay panel 410. The second light bar 422 comprises: a substrate 432, a plurality of micro LED units 442, and a controlling unit 452, wherein the substrate 432 can be a silicon substrate, and the size of the second light bar 422 can be adjusted according to the size of the reflective microdisplay panel 410. For example, the size of the reflective microdisplay panel 410 can be 0.22 inches, 0.29 inches, 0.45 inches, 0.5 inches, or 0.7 inches, and the sizes of the first light bar 420 and the second light bar 422 can be adjusted accordingly.

The micro LED units 440 are formed on the substrate 430, and each micro LED unit 440 is corresponding to a screen area in an active area 412 of the reflective microdisplay panel 410, wherein each micro LED unit 440 is corresponding to a specific number of pixels of the reflective microdisplay panel 410. The micro LED units 442 are formed on the substrate 432, and each micro LED unit 442 is corresponding to a screen area in an active area 412 of the reflective microdisplay panel 410, wherein each micro LED unit 442 is corresponding to a specific number of pixels of the reflective microdisplay panel 410. For example, the micro LED units 440 and 442 can be RGB LED units, wherein the RGB LED units can be formed in stripe arrangement or in delta arrangement, and the reflective microdisplay panel 410 is a front-lit color sequential (CS) Reflective microdisplay panel or an enhance color gamut front-lit color filter (CF) Reflective microdisplay panel. In another embodiment, the micro LED units 440 and 442 can be white LED units, and the reflective microdisplay panel 410 is a CF Reflective microdisplay panel.

The controlling unit 450 is coupled to the micro LED units 440, and utilized for controlling luminance of each of the micro LED units 440 individually according to luminance of the screen areas in the active area 412 of the reflective microdisplay panel 410. The controlling unit 452 is coupled to the micro LED units 442, and utilized for controlling luminance of each of the micro LED units 442 individually according to luminance of the screen areas in the active area 412 of the reflective microdisplay panel 410. In this way, the light source device 400 for the reflective microdisplay panel 410 is pixelated and can be controlled individually, wherein the size of the pixelated light source in the present invention is from 5 um to 0.5 mm, and the pixelated light source can be placed on a light bar or be grown on a single substrate (e.g. a silicon substrate), and the light source controller can be also integrated into the same substrate. Thus, the present invention can solve the size mismatch problem and improve the uniformity and contrast of the reflective microdisplay panel 410. Please note that the above embodiment is only for an illustrative purpose and is not meant to be a limitation of the present invention.

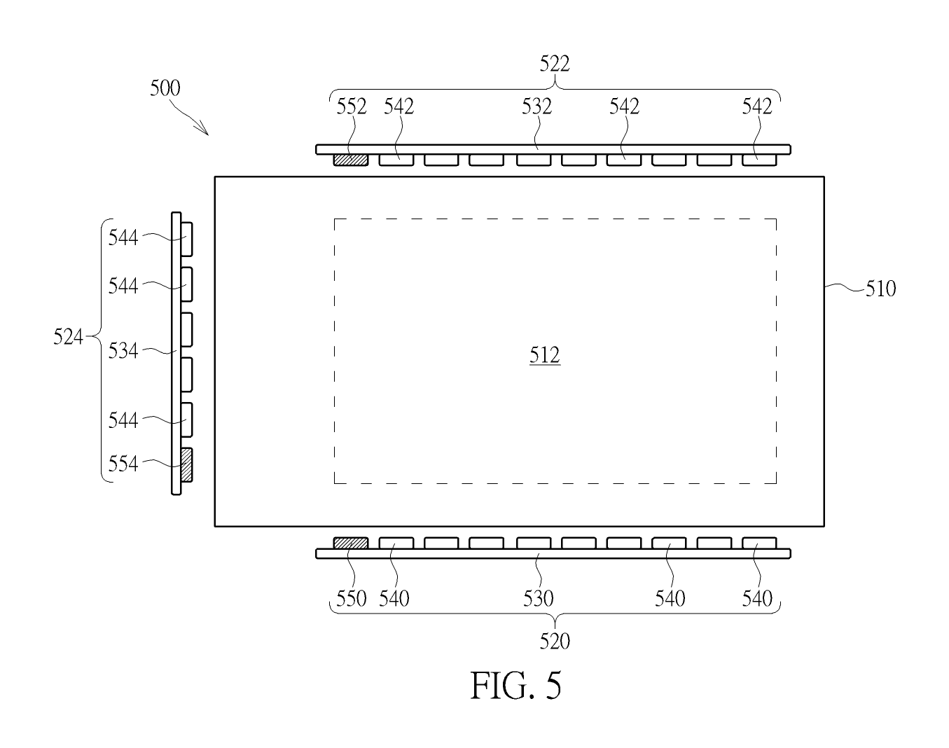

Please refer to FIG. 5. FIG. 5 shows a simplified diagram of a light source device 500 for a reflective microdisplay panel 510 in accordance with a third embodiment of the present invention. The light source device 500 comprises a first light bar 520, a second light bar 522, and a third light bar 524, wherein the first light bar 520 is disposed on a first side of the reflective microdisplay panel 510, and the second light bar 522 is disposed on a second side of the reflective microdisplay panel 510, and the third light bar 524 is disposed on a third side of the reflective microdisplay panel 510.

The first light bar 520 comprises: a substrate 530, a plurality of micro LED units 540, and a controlling unit 550, wherein the substrate 530 can be a silicon substrate, and the size of the first light bar 520 can be adjusted according to the size of the reflective microdisplay panel 510. The second light bar 522 comprises: a substrate 532, a plurality of micro LED units 542, and a controlling unit 552, wherein the substrate 532 can be a silicon substrate, and the size of the second light bar 522 can be adjusted according to the size of the reflective microdisplay panel 510. The third light bar 524 comprises: a substrate 534, a plurality of micro LED units 544, and a controlling unit 554, wherein the substrate 534 can be a silicon substrate, and the size of the third light bar 524 can be adjusted according to the size of the reflective microdisplay panel 510. For example, the size of the reflective microdisplay panel 510 can be 0.22 inches, 0.29 inches, 0.55 inches, 0.5 inches, or 0.7 inches, and the sizes of the first light bar 520, the second light bar 522, and the third light bar 524 can be adjusted accordingly.

The micro LED units 540 are formed on the substrate 530, and each micro LED unit 540 is corresponding to a screen area in an active area 512 of the reflective microdisplay panel 510, wherein each micro LED unit 540 is corresponding to a specific number of pixels of the reflective microdisplay panel 510. The micro LED units 542 are formed on the substrate 532, and each micro LED unit 542 is corresponding to a screen area in an active area 512 of the reflective microdisplay panel 510, wherein each micro LED unit 542 is corresponding to a specific number of pixels of the reflective microdisplay panel 510. The micro LED units 544 are formed on the substrate 534, and each micro LED unit 544 is corresponding to a screen area in an active area 512 of the reflective microdisplay panel 510, wherein each micro LED unit 544 is corresponding to a specific number of pixels of the reflective microdisplay panel 510. For example, the micro LED units 540, 542, and 544 can be RGB LED units, wherein the RGB LED units can be formed in stripe arrangement or in delta arrangement, and the reflective microdisplay panel 510 is a front-lit color sequential (CS) Reflective microdisplay panel or an enhance color gamut front-lit color filter (CF) Reflective microdisplay panel. In another embodiment, the micro LED units 540, 542, and 544 can be white LED units, and the reflective microdisplay panel 510 is a CF Reflective microdisplay panel.

The controlling unit 550 is coupled to the micro LED units 540, and utilized for controlling luminance of each of the micro LED units 540 individually according to luminance of the screen areas in the active area 512 of the reflective microdisplay panel 510. The controlling unit 552 is coupled to the micro LED units 542, and utilized for controlling luminance of each of the micro LED units 542 individually according to luminance of the screen areas in the active area 512 of the reflective microdisplay panel 510. The controlling unit 554 is coupled to the micro LED units 544, and utilized for controlling luminance of each of the micro LED units 544 individually according to luminance of the screen areas in the active area 512 of the reflective microdisplay panel 510. In this way, the light source device 500 for the reflective microdisplay panel 510 is pixelated and can be controlled individually, wherein the size of the pixelated light source in the present invention is from 5 um to 0.5 mm, and the pixelated light source can be placed on a light bar or be grown on a single substrate (e.g. a silicon substrate), and the light source controller can be also integrated into the same substrate. Thus, the present invention can solve the size mismatch problem and improve the uniformity and contrast of the reflective microdisplay panel 510. Please note that the above embodiment is only for an illustrative purpose and is not meant to be a limitation of the present invention.

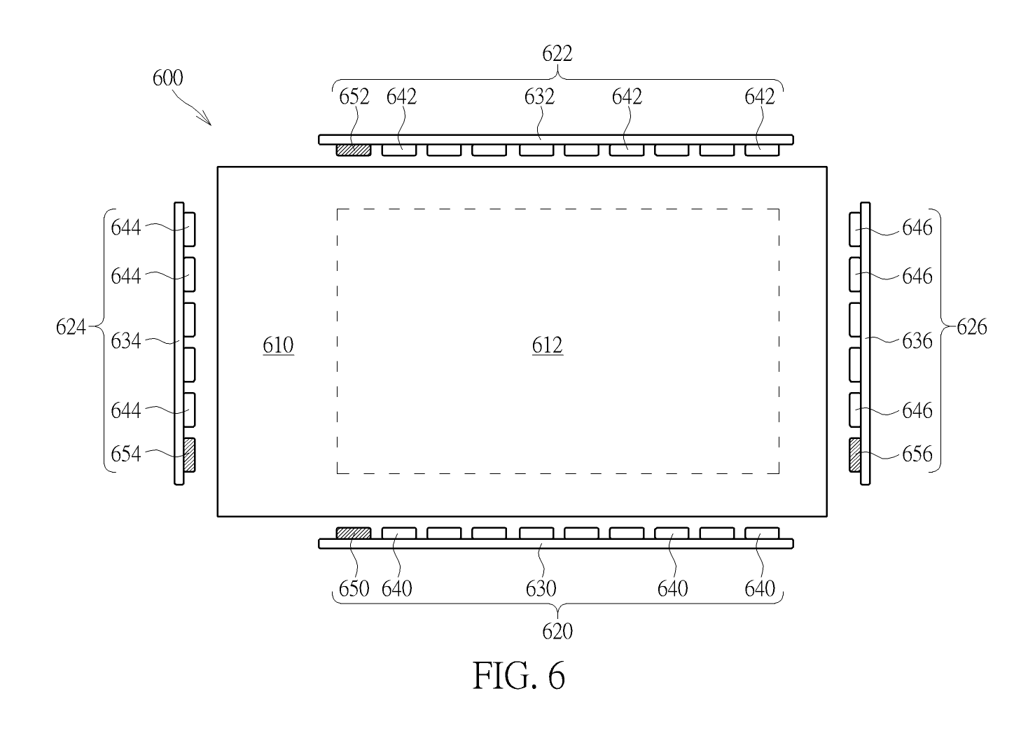

Please refer to FIG. 6. FIG. 6 shows a simplified diagram of a light source device 600 for a reflective microdisplay panel 610 in accordance with a fourth embodiment of the present invention. The light source device 600 comprises a first light bar 620, a second light bar 622, a third light bar 624, and a fourth light bar 626, wherein the first light bar 620 is disposed on a first side of the reflective microdisplay panel 610, and the second light bar 622 is disposed on a second side of the reflective microdisplay panel 610, and the third light bar 624 is disposed on a third side of the reflective microdisplay panel 610, and the fourth light bar 626 is disposed on a fourth side of the reflective microdisplay panel 610.

The first light bar 620 comprises: a substrate 630, a plurality of micro LED units 640, and a controlling unit 650, wherein the substrate 630 can be a silicon substrate, and the size of the first light bar 620 can be adjusted according to the size of the reflective microdisplay panel 610. The second light bar 622 comprises: a substrate 632, a plurality of micro LED units 642, and a controlling unit 652, wherein the substrate 632 can be a silicon substrate, and the size of the second light bar 622 can be adjusted according to the size of the reflective microdisplay panel 610. The third light bar 624 comprises: a substrate 634, a plurality of micro LED units 644, and a controlling unit 654, wherein the substrate 634 can be a silicon substrate, and the size of the third light bar 624 can be adjusted according to the size of the reflective microdisplay panel 614. The fourth light bar 626 comprises: a substrate 636, a plurality of micro LED units 646, and a controlling unit 656, wherein the substrate 636 can be a silicon substrate, and the size of the fourth light bar 626 can be adjusted according to the size of the reflective microdisplay panel 616. For example, the size of the reflective microdisplay panel 610 can be 0.22 inches, 0.29 inches, 0.65 inches, 0.6 inches, or 0.7 inches, and the sizes of the first light bar 620, the second light bar 622 the third light bar 624, and the second light bar 626 can be adjusted accordingly.

The micro LED units 640 are formed on the substrate 630, and each micro LED unit 640 is corresponding to a screen area in an active area 612 of the reflective microdisplay panel 610, wherein each micro LED unit 640 is corresponding to a specific number of pixels of the reflective microdisplay panel 610. The micro LED units 642 are formed on the substrate 632, and each micro LED unit 642 is corresponding to a screen area in an active area 612 of the reflective microdisplay panel 612, wherein each micro LED unit 642 is corresponding to a specific number of pixels of the reflective microdisplay panel 610. The micro LED units 644 are formed on the substrate 634, and each micro LED unit 644 is corresponding to a screen area in an active area 612 of the reflective microdisplay panel 614, wherein each micro LED unit 644 is corresponding to a specific number of pixels of the reflective microdisplay panel 610. The micro LED units 646 are formed on the substrate 636, and each micro LED unit 646 is corresponding to a screen area in an active area 612 of the reflective microdisplay panel 616, wherein each micro LED unit 646 is corresponding to a specific number of pixels of the reflective microdisplay panel 610. For example, the micro LED units 640, 642, 644 and 646 can be RGB LED units, wherein the RGB LED units can be formed in stripe arrangement or in delta arrangement, and the reflective microdisplay panel 614 is a front-lit color sequential (CS) Reflective microdisplay panel or an enhance color gamut front-lit color filter (CF) Reflective microdisplay panel. In another embodiment, the micro LED units 640, 642, 644 and 646 can be white LED units, and the reflective microdisplay panel 610 is a CF Reflective microdisplay panel.

The controlling unit 650 is coupled to the micro LED units 640, and utilized for controlling luminance of each of the micro LED units 640 individually according to luminance of the screen areas in the active area 612 of the reflective microdisplay panel 610. The controlling unit 652 is coupled to the micro LED units 642, and utilized for controlling luminance of each of the micro LED units 642 individually according to luminance of the screen areas in the active area 612 of the reflective microdisplay panel 610. The controlling unit 654 is coupled to the micro LED units 644, and utilized for controlling luminance of each of the micro LED units 644 individually according to luminance of the screen areas in the active area 612 of the reflective microdisplay panel 610. The controlling unit 656 is coupled to the micro LED units 646, and utilized for controlling luminance of each of the micro LED units 646 individually according to luminance of the screen areas in the active area 612 of the reflective microdisplay panel 610. In this way, the light source device 600 for the reflective microdisplay panel 610 is pixelated and can be controlled individually, wherein the size of the pixelated light source in the present invention is from 5 um to 0.5 mm, and the pixelated light source can be placed on a light bar or be grown on a single substrate (e.g. a silicon substrate), and the light source controller can be also integrated into the same substrate. Thus, the present invention can solve the size mismatch problem and improve the uniformity and contrast of the reflective microdisplay panel 610. Please note that the above embodiment is only for an illustrative purpose and is not meant to be a limitation of the present invention.

Briefly summarized, the light source device disclosed by the present invention can solve the size mismatch problem and improve the uniformity and contrast of the reflective microdisplay panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light source device for a reflective microdisplay panel, comprising:
a first light bar, disposed on a first side of the reflective microdisplay panel, comprising:
a substrate;
a plurality of micro LED units, formed on the substrate, each micro LED unit corresponding to a screen area of the reflective microdisplay panel; and
a controlling unit, coupled to the micro LED units, for controlling luminance of each of the micro LED units individually according to luminance of the screen areas of the reflective microdisplay panel.

2. The light source device of claim 1, wherein size of the first light bar can be adjusted according to size of the reflective microdisplay panel.

3. The light source device of claim 1, wherein each micro LED unit is corresponding to a specific number of pixels of the reflective microdisplay panel.

4. The light source device of claim 1, wherein the micro LED units are RGB LED units, and the reflective microdisplay panel is a front-lit color sequential (CS) Reflective microdisplay panel or an enhance color gamut front-lit color filter (CF) Reflective microdisplay panel.

5. The light source device of claim 4, wherein the RGB LED units are formed in stripe arrangement or in delta arrangement.

6. The light source device of claim 1, wherein the micro LED units are white LED units, and the reflective microdisplay panel is a CF Reflective microdisplay panel.

7. The light source device of claim 1, wherein the substrate is a silicon substrate.

8. The light source device of claim 1, further comprising:
a second light bar, disposed on a second side of the reflective microdisplay panel, comprising:
a substrate;
a plurality of micro LED units, formed on the substrate, each micro LED unit corresponding to a screen area of the reflective microdisplay panel; and
a controlling unit, coupled to the micro LED units, for controlling luminance of each of the micro LED units individually according to luminance of the screen areas of the reflective microdisplay panel.

9. The light source device of claim 8, wherein size of the second light bar can be adjusted according to size of the reflective microdisplay panel.

10. The light source device of claim 1, further comprising:
a third light bar, disposed on a third side of the reflective microdisplay panel, comprising:
a substrate;
a plurality of micro LED units, formed on the substrate, each micro LED unit corresponding to a screen area of the reflective microdisplay panel; and
a controlling unit, coupled to the micro LED units, for controlling luminance of each of the micro LED units individually according to luminance of the screen areas of the reflective microdisplay panel.

11. The light source device of claim 10, wherein size of the third light bar can be adjusted according to size of the reflective microdisplay panel.

12. The light source device of claim 1, further comprising:
a fourth light bar, disposed on a fourth side of the reflective microdisplay panel, comprising:
a substrate;
a plurality of micro LED units, formed on the substrate, each micro LED unit corresponding to a screen area of the reflective microdisplay panel; and
a controlling unit, coupled to the micro LED units, for controlling luminance of each of the micro LED units individually according to luminance of the screen areas of the reflective microdisplay panel.

13. The light source device of claim 12, wherein size of the fourth light bar can be adjusted according to size of the reflective microdisplay panel.

14. The light source device of claim 1, wherein the reflective microdisplay panel is a liquid crystal on a silicon (LCOS) panel, a DMD panel, or an epaper panel.
